(19) United States
(12) Patent Application Publication
(10) Pub. No.: US 2001/0030190 A1
(43) Pub. Date: Oct. 18, 2001

(54) Confection cup assembly

(76) Inventors: Richard E. Vogel, Mason, MI (US); Timothy J. Foltz, Holt, MI (US)

Correspondence Address: RADER, FISHMAN, GRAUER & MCGARRY PLLC, 171 MONROE AVENUE, N.W., SUITE 600, GRAND RAPIDS, MI, 49503, US

(21) Appl. No.: 09/681,099

(22) Filed: Jan. 4, 2001

Related U.S. Application Data
(60) Provisional application No. 60/175,620, filed on Jan. 11, 2000.

(51) Int. Cl. B65D 6/28; B65D 8/18; A47J 39/00; A47J 41/00

(52) U.S. Cl. 220/4.03; 220/592.14

(57) ABSTRACT

A confection cup assembly comprising a sleeve that slidably receives a confection cup and a collar having a portion that is slidably received within the open top of a confection cup in a manner such that a portion of the sleeve and collar overlap and retain the cup therebetween.

### CROSS REFERENCE TO RELATED APPLICATIONS

This application claims the benefit of U.S. Provisional Application Ser. No. 60/175,620, Jan. 11, 2000.

### BACKGROUND OF INVENTION

1. Field of the Invention

The invention relates to an apparatus for manufacturing a confection, and more particularly, a confection cup assembly for structurally supporting a confection cup during the mixing of the confection ingredients.

2. Description of the Related Art

Liquid confections, such as a smoothie, malt or milkshake, are commonly formed from a variety of ingredients that include ice, juices and fruit for a smoothie, and malt powder, candies, toppings, and other filling materials in addition to the ice cream for malts or milkshakes. The ingredients are typically mixed using a mixer having a rotating beater.

Traditionally, confections of this type were mixed in a rigid container, preferably made from stainless steel, and then served in a glass cup or tumbler. The stainless steel mixing container had sufficient structural strength to resist damage when contacting the mixer beater. The stainless steel containers tended to be of sufficient volume to retain all of the confection ingredients without splashing during the mixing step. The strength of the stainless steel could also withstand the striking of the container on a countertop to help the ingredients settle, which is a common practice when making a malt.

With the development of disposable serving containers, such as paper or foam cups, the stainless steel mixing container has lost favor to mixing the confection ingredients directly in the disposable cup. A collar is used with the disposable cup to effectively extend the length of the cup to contain the confection ingredients within the container during mixing. Foam cups are preferred over paper cups for temperature sensitive confections because the paper cups have a relatively low insulation value, resulting in the relatively rapid melting of the confection.

Previous attempts to mix the confection ingredients directly in a disposable cup have met with failure because the resulting thick concoctions laden with dense lumps of candy/fruit/ice agitated/mixed at high speed caused pressures against the inside walls and bottom of the cups, resulting in the bursting or puncture of the cup walls. While mixing can cause cup failure, failure can also be caused by striking the cup on the counter surface in order to settle the mix prior to removing the collar.

There is a need and desire to find a solution that will permit direct mixing of liquid confections in a disposable cup without damaging the cup.

### SUMMARY OF INVENTION

The invention relates to a confection cup assembly for mixing the ingredients for a liquid confection such as a malt, milkshake, or smoothie. The confection cup assembly comprises a conventional disposable cup, and a collar and sleeve according to the invention. The cup comprises a cup body and an open top, with the cup body defining a cup recess and the cup open top providing access to the cup recess. The cup body further comprises a bottom wall closing the cup opposite the cup open top. The collar has an insert portion sized to be slidably received within the open top of the cup. The collar further has an extension portion extending above the open top of the cup, and the junction of the extension portion and the insert portion forms a shoulder that abuts the open top to limit the insertion of the collar into the cup in the axial direction.

The sleeve comprises a sleeve body, an open top, and a bottom wall closing the sleeve opposite the open top. The sleeve body defines a sleeve recess and the sleeve open top provides access to the sleeve recess, the sleeve being sized to slidably receive the cup. The sleeve body preferably tapers inwardly in a direction away from the open top. At least a portion of the sleeve bottom wall is in abutting relationship with at least a portion of the cup bottom wall. The bottom wall preferably includes at least one air passage extending therethrough. A portion of the sleeve body axially overlaps a portion of the collar insert portion to compress the cup therebetween to frictionally retain a portion of the cup along the overlap portion. The cup exterior surface and the sleeve recess interior surface are in abutting relationship along the portion of the cup extending into the sleeve recess.

A friction enhancer is preferably provided on at least the collar overlap surface or the sleeve overlap surface, the enhancer comprising rubber or at least one protrusion extending outwardly from the exterior surface of the insert portion.

### BRIEF DESCRIPTION OF DRAWINGS

In the drawings:

FIG. 1 illustrates a sectional view of a confection cup assembly according to the invention, including a collar and a sleeve operably coupled to a confection cup;

FIG. 2 is a top plan view of the collar;

FIG. 3 is a longitudinal sectional view of the collar taken along line 3-3 of FIG.

FIG. 4 is a top plan view of the sleeve;

FIG. 5 is a longitudinal sectional view of the sleeve taken along line 5-5 of FIG. 1;

FIG. 6 is an enlarged detail of a lip of the sleeve of FIG. 5;

FIG. 7 is an enlarged bottom detail of the sleeve of FIG. 5;

FIG. 8 is a top plan view of a first alternative construction of the sleeve;

FIG. 9 is a sectional view taken along line 9-9 of FIG. 8;

FIG. 10 is a sectional view similar to FIG. 3 of a first alternative construction for the collar;

FIG. 11 is a sectional view similar to FIG. 5 of a second alternative construction for the sleeve; and

FIG. 12 is a sectional view similar to FIG. 3 of a second alternative construction for the collar.

### DETAILED DESCRIPTION

FIG. 1 illustrates a confection cup assembly 10 according to the invention. The confection cup assembly 10 comprises a collar 12 having a portion inserted within an open top of a conventional disposable confection cup 14, which is retained within a sleeve 16. The collar 12 and sleeve 16 interact to prevent the rotation of the confection cup 14 during the mixing of the confection ingredients. The sleeve 16 adds additional structural rigidity to the confection cup 14 to prevent damage of the cup during the mixing of the confection ingredients, especially from the pressure exerted on the cup walls from the dense and particle-laden confection slurry, and from the impact when the confection cup is struck against a work surface to encourage the confection ingredients to settle.

It is worth noting that the confection cup 14 is of no particular or special design. It can be any type of cup, i.e., foam, paper, or otherwise. Preferably, the cup is made from expanded polystyrene. A foam cup is preferred because of its superior insulating qualities. The cup comprises a tapered peripheral wall 17 that defines an interior recess 18. A bottom wall 19 closes one end of the interior recess 18. An annular rib 21 extends from the bottom wall 19. An annular lip 30 defines an open top through which access to the interior recess 18 is gained.

Referring to FIGS. 1-3, the collar 12 comprises an insert portion 20 and an extension portion 22 whose junction forms an annular shoulder 24. The insert portion 20 has an outer diameter sized so that it will be snugly received within the confection cup 14. Additionally, the profile of the insert portion is complementary to the profile of the confection cup, which are continuously tapered.

The extension portion 22 is illustrated as having an outwardly tapered cross-sectional profile terminating in an upper lip 26, which provides the open top of the extension 22 with additional hoop strength and a structure for mounting a lid (not shown), if desired. The tapered cross section of the extension 22 yields a larger access opening for the collar 12, resulting in greater convenience for the user. However, it is not necessary for the invention that the extension 22 have a tapered profile.

The annular shoulder 24 is preferably of a diameter such that at least a portion of an upper end 30 of the cup 14 will abut the annular shoulder 24 upon the insertion of the insert portion 20 of the collar 12 into the open top of the cup 14 to thereby limit the insertion depth of the collar 12 into the cup 14.

The collar is preferably made from high impact polystyrene. It can also be made from any other suitable material such as plastic or stainless steel.

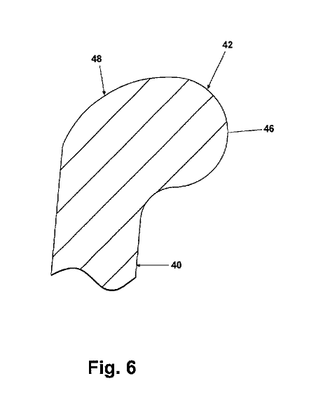

Referring to FIGS. 1, 4, and 5, the sleeve 16 comprises a body 40 defining a sleeve recess 45 having a longitudinally tapered cross section, terminating in an open top defined by an outwardly directed annular lip 42 on one end and a closed bottom formed by a bottom wall 44 on the opposing end. The cross-sectional profile of the body 40 preferably conforms to the cross-sectional profile of the cup 14, so that when the cup is completely received within the sleeve 16, the cup will be in abutting relationship with at least a portion, and preferably over the entire inner surface 41, of the body 40 of the sleeve 16.

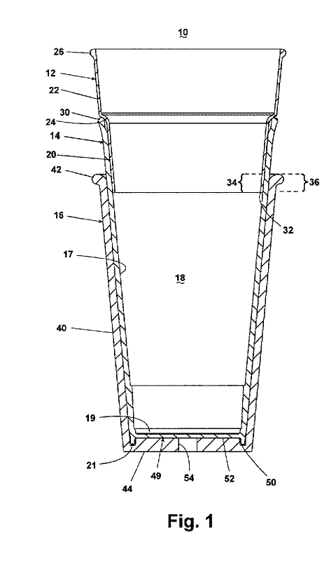

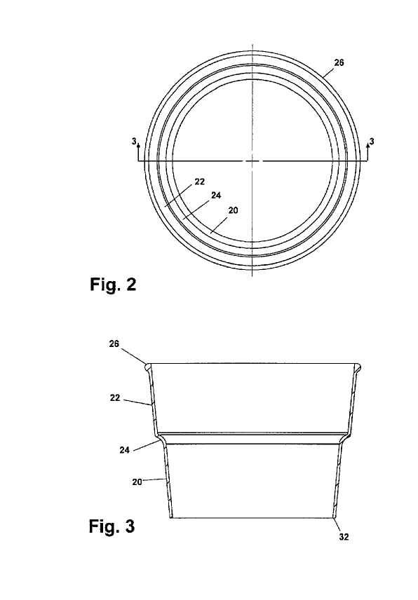

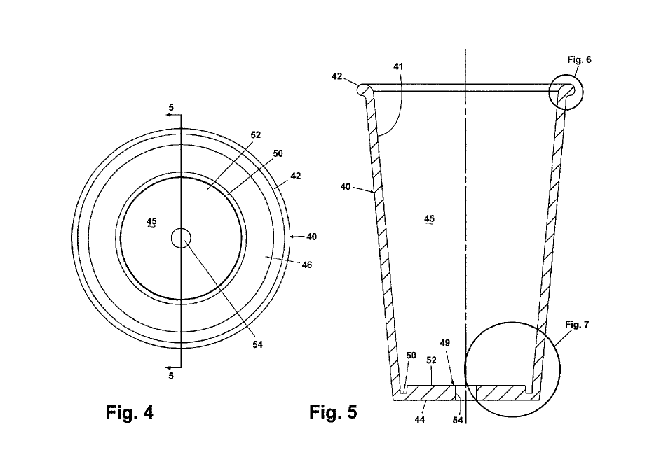

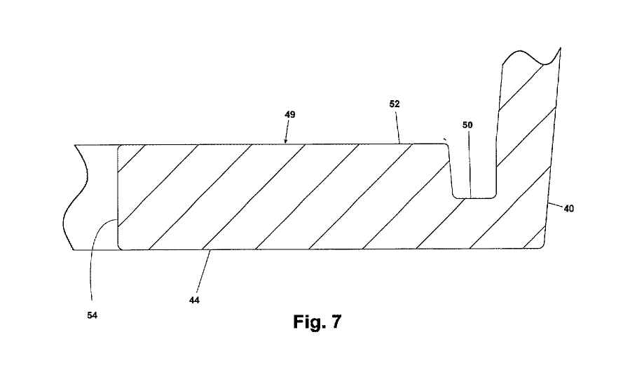

Referring to FIGS. 4-6, the lip 42 includes a rounded lobe 46 extending away from the body 40 and a rounded upper surface 48 merging with the inner surface of the body 40. The rounded upper surface 48 aids in the insertion of the cup 14 by eliminating any sharp contours on which the bottom of the cup might catch during insertion.

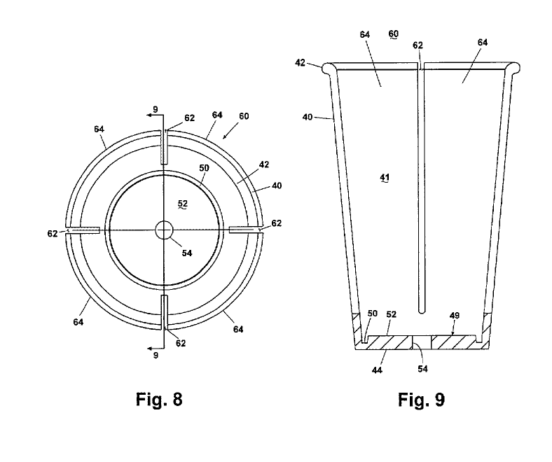

Referring to FIGS. 4, 5, and 7, the bottom wall 44 comprises an upper surface 49 that conforms to the base of the cup by providing an annular channel 50 defining and circumscribing a raised platform 52. The annular channel 50 and platform 52 conform to the shape of the illustrated confection cup bottom so that the external surface of the confection cup bottom is substantially completely supported by the platform 52.

The particular shape of the sleeve bottom wall 44 can vary depending on the shape of the cup bottom wall to be used with the sleeve 16. The illustrated bottom wall is suitable for cups that have an annular rib extending from the bottom wall (the illustrated cup) and cups that do not incorporate an annular rib. The platform 52 is of sufficient size to adequately support either cup shape.

The bottom wall 44 also includes an opening 54 extending entirely therethrough. The opening enables air to freely enter and exit the sleeve during the insertion and removal of the cup to relieve air pressure and ease the insertion and removal of the cup and ensure that the cup is properly seated against the bottom wall of the sleeve 16.

The length of the sleeve 16 and the length of the insert portion 20 of the collar 12 are such that a portion of the confection cup 14 is frictionally and/or compressively retained therebetween. Preferably, the length of the sleeve 16 and the length of the collar insert portion 20 are such that the bottom 32 of the collar insert portion 20 extends below the lip 42 of the sleeve 16 to define a collar overlap area 34 and a sleeve overlap area 36 when the collar 12, confection cup 14, and sleeve 16 are assembled. Further, the inner diameter of the sleeve 16 and the outer diameter of the insert portion 20 along the overlap areas 34, 36 are such that they define a gap therebetween that is equal to or less than the thickness of the confection cup 14 along at least a portion of the overlap areas 34, 36 to ensure that at least a portion of the confection cup 14 is compressively retained between the sleeve 16 and the insert portion 20 of the collar 12.

The sleeve is preferably made from high impact polystyrene. It can also be made from any other suitable material such as plastic or metal.

Spinning of the confection cup 14 relative to the sleeve 16 or collar 12 during mixing of the confection ingredients would substantially impair the ability to properly mix the confection ingredients. With a confection cup assembly 10 according to the invention, the confection ingredients can easily be mixed within the cup 14 without the cup 14 spinning relative to either the collar 12 or the sleeve 16 since the cup is frictionally retained between the collar 12 and the sleeve 16 and the frictional retaining force is increased by the compressive force applied by the collar 12 and sleeve 16 on the cup. The sleeve 16 also provides additional structural rigidity to the cup 14 in that the confection ingredients can be freely mixed without bursting or puncturing of the cup walls. The user of the cup assembly 10 can also strike the sleeve 16 on a counter to encourage the ingredients to settle without damaging the cup 14.

It is worth noting that since the entire inner surface 41 of the sleeve 16 substantially conforms to the exterior surface of the confection cup 14, when the sleeve is struck on a countertop to encourage the settling of the ingredients, there will be no relative movement between the confection cup 14 and the sleeve 16, which might otherwise damage the cup 14 if it were to move relative to the sleeve 16 and impact the sleeve 16 during striking.

FIGS. 8 and 9 illustrate an alternative structure of the sleeve of the invention. The alternative sleeve 60 is substantially identical to the sleeve 16. Therefore, like numerals will be used to identify like elements and only the distinctions will be described in detail. The main difference between the sleeve 60 and the sleeve 16 is that the sleeve 60 includes at least one, but preferably multiple, longitudinal slots 62 extending substantially along the entire length of the body 40, dividing the body into multiple sections 64. The slots 62 permit the inner diameter of the sleeve 60 to be adjusted by the user by merely squeezing the body 40 to press the various body sections 64 into contact with the confection cup 14. Thus, with the sleeve 60, if the user detects any spinning of the confection cup 14 relative to the sleeve or collar, the user need merely squeeze the sleeve 60 and deflect the sections 64 of the sleeve 60 inwardly toward the cup to add compressive force directly to the exterior of the cup and improve any compressive or frictional retention between the overlapping portions of the sleeve 60 and the collar 12 and between the sleeve and the cup alone. The sleeve 60 also can accommodate cups which vary slightly dimensionally since at least a portion of the sleeve's dimensions can easily be changed by the user squeezing the sleeve 60.

It should be noted that the sleeve 60 can be used without the collar 12 since the user can control the amount of compressive force that the sleeve 60 applies to the confection cup 14. The user can limit any spinning of the cup 14 with respect to the sleeve 60 regardless of whether or not the collar 12 is used. However, it is preferred that the collar 12 be used in combination with the sleeve 60 as it can inhibit the user from over-squeezing the sleeve 60. Further, the collar extension portion 22 aids in retaining the confection ingredients within the cup 14, and the upper lip 26 of the collar provides a rigid surface for securely engaging an “on-off” trigger in those mixing devices having such a feature.

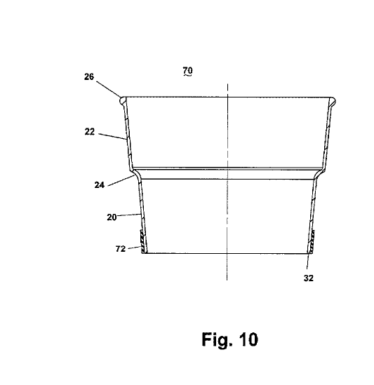

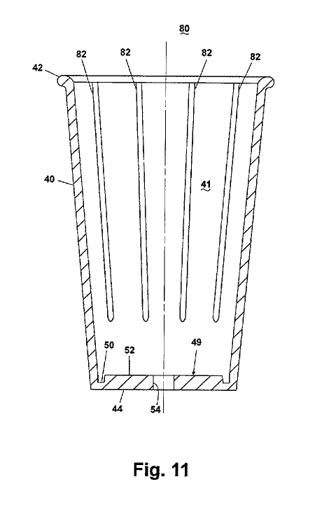

FIG. 10 illustrates an alternative construction of the collar. The alternative collar 70 is substantially identical to the collar 12 except that a thin layer of frictional material 72 is disposed about the periphery of the insert portion 20, preferably along the portion of the insert portion forming part of the overlap area 34. The frictional material 72 can be rubber or any other material that increases the frictional resistance between the insert portion 20 of the collar 12 and the interior of the cup 14. The frictional material 72 will improve the tendency of the confection cup 14 to remain stationary relative to the collar 12 and the sleeve 16 during the mixing of the confection ingredients. It is within the scope of the invention for at least the insert portion 20 of the collar 12 to be made from a material that is highly frictional instead of the addition of a separate friction layer or coating. The frictional material 72 can also be applied to the sleeve overlap area 36. Similarly, the sleeve 16 can be made entirely from a frictional material with sufficient rigidity.

FIG. 11 illustrates a second alternative construction of the sleeve 16. The second alternative construction of the sleeve 80 is identical to that of the sleeve 16 except that a series of ribs 82 extend inwardly along the inner surface 41 of the body 40. The ribs 82 preferably extend a sufficient distance from the inner surface 41 of the body 40 so that they will abut and depress a portion of the exterior surface of the confection cup 14 when the confection cup is inserted into the sleeve 16. The ribs 82 will retard the tendency of the confection cup 14 to spin relative to the sleeve 16. Similar ribs can also be provided on the exterior surface of the insert portion 20 of the collar 12.

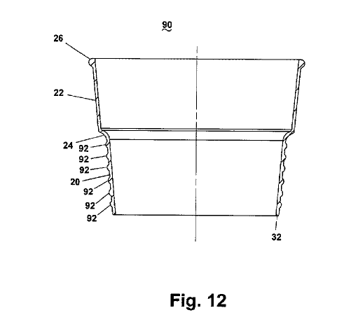

FIG. 12 illustrates a second alternative construction of the collar. The second alternative construction of the collar 90 is identical to that of the collar 12 except for the addition of a series of bumps, protrusions, or embossments 92 extending outwardly from the exterior surface of the insert portion 20. The bumps 92 function in a manner similar to that of the ribs 82 of the sleeve 80. The bumps 92 abut and depress a portion of the inner surface of the confection cup 14 to retard the tendency of the confection cup 14 to spin relative to the collar 12. The bumps 92 can also be provided on the inner surface 41 of the sleeve 16.

While the invention has been specifically described in connection with certain specific embodiments thereof, it is to be understood that this is by way of illustration and not of limitation, and the scope of the appended claims should be construed as broadly as the prior art will permit.

1. A confection cup assembly for mixing the ingredients of a confection in a cup, the cup comprising a cup body having an open top, the cup body defining a cup recess, the open top providing access to the cup recess, and a bottom wall opposite the open top closing an end of the cup body, the confection cup assembly comprising:
a collar having an insert portion sized to be slidably received within the cup open top and into the cup recess;
and a sleeve comprising a sleeve body having an open top, the sleeve body defining a sleeve recess and the sleeve open top providing access to the sleeve recess, the sleeve being sized to slidably receive the cup;
a portion of the sleeve overlapping a portion of the collar insert portion when the cup is inserted into the sleeve and the collar is inserted into the cup to compress the cup therebetween and frictionally retain the cup therebetween.

2. The confection cup assembly according to claim 1, wherein the cup exterior profile and the sleeve recess interior profile are complementary at least along a portion of the cup extending into the sleeve recess.

3. The confection cup assembly according to claim 1, wherein the sleeve further comprises a bottom wall closing the sleeve opposite the open top.

4. The confection cup assembly according to claim 3, wherein the bottom wall comprises at least one air passage extending therethrough.

5. The confection cup assembly according to claim 4, wherein the sleeve upper surface and the cup lower surface are in abutting relationship.

6. The confection cup assembly according to claim 1, wherein the sleeve body tapers in a direction away from the open top.

7. The confection cup assembly according to claim 1, wherein the collar further comprises an extension portion extending above the open top of the cup.

8. The confection cup assembly according to claim 7, wherein the junction of the extension portion and the insert portion forms a shoulder that abuts the open top to limit the insertion of the collar into the cup.

9. The confection cup assembly according to claim 1, and further comprises a friction enhancer provided on at least one of the collar and sleeve.

10. The confection cup assembly according to claim 9, wherein the friction enhancer is provided on the insert portion of the collar.

11. The confection cup assembly according to claim 9, wherein the friction enhancer is provided on the overlap portion of at least one of the collar and the sleeve.

12. The confection cup assembly according to claim 11, wherein the friction enhancer comprises a frictional material.

13. The confection cup assembly according to claim 12, wherein the frictional material is rubber.

14. The confection cup assembly according to claim 11, wherein the friction enhancer comprises at least one protrusion extending outwardly from an exterior surface of the insert portion.

15. The confection cup assembly according to claim 14, wherein the protrusion is an annular rib.

16. The confection cup assembly according to claim 14, wherein the protrusion is an embossment.

17. The confection cup assembly according to claim 14, wherein the protrusion is a longitudinal rib extending away from an interior surface of the sleeve.

18. The confection cup assembly according to claim 1, wherein the sleeve body comprises at least one longitudinal slot extending therethrough to permit the sleeve body to be deflected toward the cup and thereby apply a compressive force to the cup to frictionally restrain the cup from movement relative to the sleeve body.

19. A confection cup assembly for mixing the ingredients for a confection in a cup, the cup comprising a cup body having an open top, the cup body defining a cup recess, the cup open top providing access to the cup recess, and a bottom wall closing the cup opposite the cup open top, the confection cup assembly comprising:
a collar having an insert portion sized to be slidably received within the cup open top and into the cup recess; and
a sleeve comprising a sleeve body, an open top, and a bottom wall closing the sleeve opposite the open top, the sleeve body defining a sleeve recess, the sleeve open top providing access to the sleeve recess, the sleeve being sized to slidably receive the cup such that at least a portion of the sleeve bottom wall is in abutting relationship with at least a portion of the cup bottom wall.

20. The confection cup assembly according to claim 19, wherein a portion of the sleeve body overlaps a portion of the collar insert portion to compress the cup therebetween and frictionally retain a portion of the cup along the overlap portion.

21. The confection cup assembly according to claim 19, wherein the cup exterior surface and the sleeve recess interior surface are in abutting relationship along at least a portion of the cup extending into the sleeve recess.

22. The confection cup assembly according to claim 19, wherein the bottom wall comprises at least one air passage extending therethrough.

23. The confection cup assembly according to claim 19, wherein the sleeve body tapers in a direction away from the open top.

24. The confection cup assembly according to claim 19, wherein the collar further comprises an extension portion extending above the open top of the cup.

25. The confection cup assembly according to claim 24, wherein the junction of the extension portion and the insert portion forms a shoulder adapted to abut the cup open top to limit the insertion of the collar into the cup.

26. The confection cup assembly according to claim 19, further comprising a friction enhancer provided on at least one of the collar and sleeve.

27. The confection cup assembly according to claim 26, wherein the friction enhancer is provided on the insert portion of the collar.

28. The confection cup assembly according to claim 26, wherein the friction enhancer is provided on the overlap portion of at least one of the collar and the sleeve.

29. The confection cup assembly according to claim 26, wherein the friction enhancer comprises a frictional material.

30. The confection cup assembly according to claim 26, wherein the friction enhancer comprises at least one protrusion extending outwardly from an exterior surface of the insert portion or an interior surface of the sleeve.

31. The confection cup assembly according to claim 19, wherein the sleeve body comprises at least one longitudinal slot extending therethrough to permit the sleeve body to be deflected toward the cup and thereby apply a compressive force to the cup to frictionally restrain the cup from movement relative to the sleeve body.

32. A confection cup assembly for mixing the ingredients for a confection, the confection cup assembly comprising:
a cup comprising a cup body having an open top, the cup body defining a cup recess, the cup open top providing access to the cup recess, and a bottom wall closing the cup opposite the cup open top;
a collar having an insert portion sized to be slidably received within the cup open top and into the cup recess; and
a sleeve comprising a sleeve body having an open top, the sleeve body defining a sleeve recess and the sleeve open top providing access to the sleeve recess, the sleeve being sized to slidably receive the cup;
a portion of the sleeve overlapping a portion of the collar insert portion when the cup is inserted into the sleeve and the collar is inserted into the cup to compress the cup therebetween and frictionally the cup therebetween.

33. The confection cup assembly according to claim 32, wherein a portion of the sleeve body overlaps a portion of the collar insert portion to compress the cup therebetween to frictionally retain a portion of the cup along the overlap portion.

34. The confection cup assembly according to claim 33, and further comprises a friction enhancer provided on at least one of the collar and sleeve.

35. The confection cup assembly according to claim 34, wherein the friction enhancer is provided on the insert portion of the collar.

36. The confection cup assembly according to claim 34, wherein the friction enhancer is provided on the overlap portion of at least one of the collar and the sleeve.

37. The confection cup assembly according to claim 34, wherein the friction enhancer comprises a frictional material.

38. The confection cup assembly according to claim 34, wherein the friction enhancer comprises at least one protrusion extending outwardly from an exterior surface of the insert portion or an interior surface of the sleeve.
